(19) United States
(12) Patent Application Publication
(10) Pub. No.: US 2005/0265031 A1
(43) Pub. Date: Dec. 1, 2005

(54) Underwater multipurpose illumination device

(75) Inventors: D. Michael Mosholder JR., East Lansing, MI (US); Jeffrey T. Beach, Williamston, MI (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Aqua-Glo, LLC, Lansing, MI (US)

(21) Appl. No.: 10/857,500

(22) Filed: Jun. 1, 2004

(51) Int. Cl. F21V 21/00; F21V 5/00

(52) U.S. Cl. 362/368; 362/276; 362/326

(57) ABSTRACT

An illumination device includes a housing and a lens disposed at the end of the housing. The lens is in watertight engagement with the housing and includes at least one LED disposed in the housing and for transmitting light through the lens. An infrared sensor is operatively connected to the electronic control unit for remotely operating the electronic control unit. The illumination device also includes a mounting disk and bracket for mounting to underwater surfaces, such as a pool. An electronic driver unit regulates power to the LED module, thereby saving battery power.

### FIELD OF THE INVENTION

The present invention relates to illumination systems. More particularly, the present invention relates to underwater illumination systems.

### BACKGROUND OF THE INVENTION

Many devices have been proposed for illuminating bodies of waters, such as pools. For example, previous illumination systems for underwater lighting include providing lights on poles shining down on the body of water. However, lights mounted on poles shining on a body of water create the effect of diffused light, which illuminates surrounding areas more than the intended body of water.

Another prior art system includes the use of electrical units installed directly in a pool lining underground. For example, U.S. Pat. No. 6,184,628 discloses a pool light for mounting in a cavity of the pool below the water surface. A 12 volt-ac power source is provided for supplying power to the light source. However, there are many disadvantages in connection with these underground systems. With regard to internal light sources, strong electrical currents are sometimes used to operate these systems. In addition, specialists are needed to install the systems to avoid underwater shock and electrocution. Further, specific regulations must be followed in order to provide against underwater shock and electrocution. For example, electrical cable lines have to be buried underground. These types of installations can be very costly, and the risk of electrocution is never totally eliminated.

Other external light sources like waterproof flashlights are handheld. However, these flashlights only provide light that is emitted in a beam rather than diffused to the water. Therefore, the pool is not uniformly illuminated.

There are also lights that float in the pool downwardly. For example, U.S. Pat. No. 3,748,457 discloses a safety light for a swimming pool that is disc-like in structure, and that floats in water. However, these lights have drawbacks in that they must be avoided by the occupants of the pool. In addition, these lights constantly move, thereby changing the uniformity of lighting within the pool.

### SUMMARY

The present invention is directed to an illumination device comprising a housing, and a lens disposed at the end of the housing, where the lens is in watertight engagement with the housing. At least one LED bulb is disposed in the housing for transmitting light through the lens. A power source is provided for illuminating the at least one LED bulb. An electronic control unit is provided for directing power from the power source to the at least one LED bulb. An infrared sensor is operatively connected to the electronic control unit for remotely operating the electronic control unit.

Another aspect of the present invention pertains to a mountable illumination device. The device includes a housing, a light source disposed at the end of the housing, and a backing plate disposed at an opposite end of the housing. A mounting disk is removably attached to the backing plate and is provided for mounting the illumination device on a surface.

According to yet another aspect of the present invention, an illumination device includes a housing and a lens disposed at the end of the housing. The lens is in watertight engagement with the housing. At least one light source is disposed in the housing for transmitting light through the lens. The lens is shaped so that light is transmitted at an angle perpendicular to a front surface of the lens.

### BRIEF SUMMARY OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is a cross-sectional view of an exemplary embodiment of the present invention;

FIG. 2 is a top plan view of an exemplary embodiment of the present invention;

FIG. 3 is a side elevational view of the mounting disk and bracket of an exemplary embodiment of the present invention;

FIG. 4 is a perspective view of the lens according to an exemplary embodiment of the present invention;

FIG. 5 is a cross-sectional view of the lens of FIG. 4; and

FIG. 6 is a perspective view of the lens, with portions taken away, of an exemplary embodiment of the present invention showing how light is refracted through the lens.

### DETAILED DESCRIPTION OF THE PREFERRED EMBODIMENTS

With reference to the figures, exemplary embodiments of the present invention will now be described. The scope of the invention disclosed is applicable to uses in addition to illuminating swimming pools. For example, the present invention is also applicable to illuminating other underwater areas such as docks and underwater landscaping features. The device may also be used for other recreational activities, such camping and backyard illumination.

FIG. 1 illustrates a cross-sectional view of the illumination device 100 according to an exemplary embodiment of the present invention. The illumination device 100 includes a main housing 102 with a lens 104 disposed at the end of the housing 102. The lens 104 is in watertight engagement with the main housing 102. Preferably, both lens 104 and main housing 102 are made from a plastic material, and are sonic welded together. However, it should be understood that main housing 102 and lens 104 can be made from any other material that is resistant to water and water corrosive effects. In addition, it should be understood that main housing 102 and lens 104 may be connected in other ways known in the art, such as by a waterproof adhesive.

The illumination device 100 includes an LED module 106 for illuminating the device. The LED module is made up of at least one LED bulb. Preferably, the LED module 106 emits a white light. Alternatively, the LED module 106 may emit a plurality of lights, such as red, green and blue lights. However, the LED module 106 is not limited to these color selections. Preferably, the LED module 106 is 0.5 mm in diameter by 0.200 mm in height. However, different size and shape LED modules may also be used, depending on design preference.

The LED module 106 is disposed in the housing adjacent the lens 104 for transmitting light through the lens 104. The LED module 106 is mounted behind the lens 104 on an electronic mounting plate 108, in a first compartment 109. Mounted on the opposite side of the electronic mounting plate 108 is an electronic control unit 110.

A divider plate 112 is disposed adjacent to, but spaced from the electronic mounting plate 108 thereby defining a second compartment 113. Preferably, the divider plate 112 and electronic mounting plate 108 are attached to the housing 102 via a plurality of screws 114, which are disposed underneath the sonic weld and inside the main housing 102. However, it should be understood that the divider plate 112 may be attached in other ways, such as by an adhesive or through bonding.

A backup plate 116 is disposed adjacent to, but spaced from the divider plate 112 thereby defining a third compartment 117. A power source 118 is disposed between the divider plate 112 and the backup plate 116 in the third compartment 117. The divider plate 112 includes an aperture 120 for directing wires from the power source 118 to the electronic control unit 110. Preferably, the power source is at least one battery, or a plurality of batteries. According to a preferred embodiment, the batteries are nested in a straight line next to one another. However, it should be understood that the batteries may be arranged in other ways known in the art.

The illumination device 100 may also optionally include an on/off button 122. The on/off button 122 is disposed on the side of the housing 102, but may be disposed in any other location. Preferably, the on/off button 122 is rubberized, and is designed to be resistant to water. In an alternative embodiment, a magnetic reed switch can be used instead of the disclosed on/off button.

The illumination device 100 may also include a two-pronged receptacle 124 for recharging the power source 118. The two-pronged receptacle 124 allows the illumination device 100 to be recharged with an adapter at a convenient location. The receptable 124 is similar to that used in recharging cellular telephones, and the like.

The illumination device 100 also optionally includes a mounting disk 126. The mounting disk 126 is removable, and can be attached to the backup plate 116 via a screw 128. Preferably, the backup plate 116 includes a threaded hole on the outside to attach the mounting disk 126. Details of the mounting disk 126 will be described in more detail below.

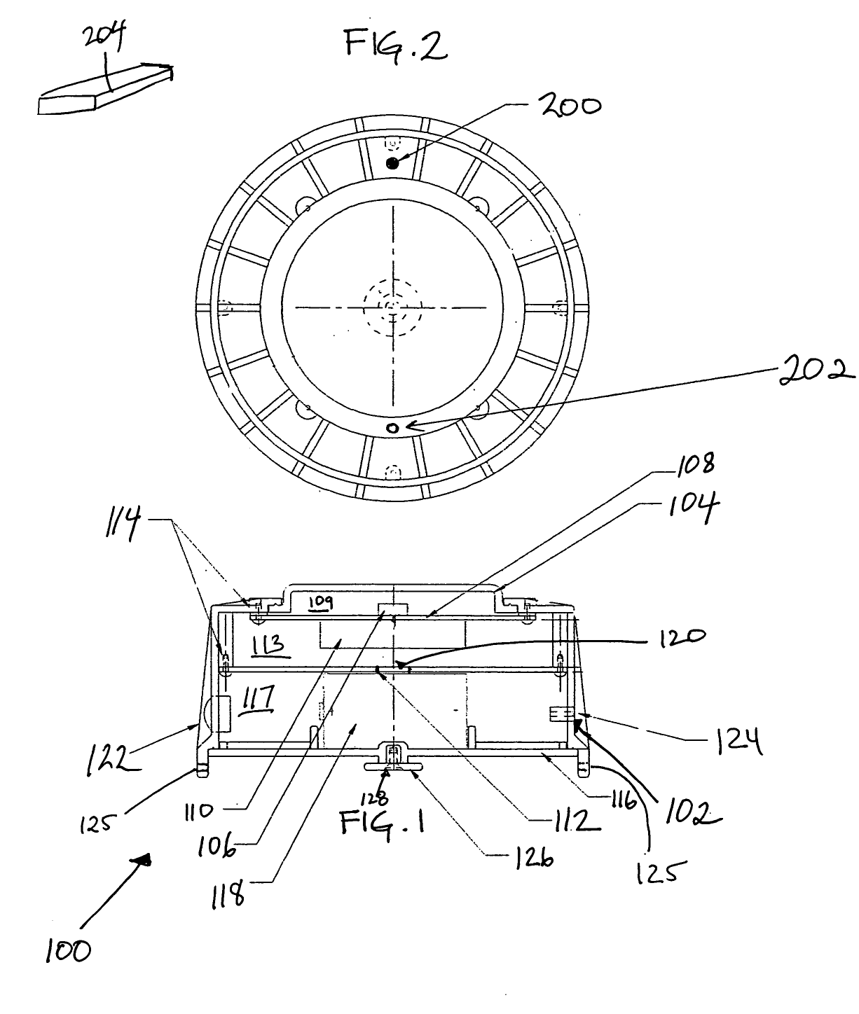

The illumination device 100 is capable of being submerged underwater to provide diffused light to that body of water. With reference to FIG. 2, an IR sensor 200 is provided. The IR sensor 200 is operatively connected to the electronic control unit (FIG. 1), for remotely operating the electronic control unit. In particular, a remote control unit, such as one used for keyless entry into a car, can activate the infrared sensor 200 to turn the LED module on and off.

In the preferred embodiment, the infrared sensor 200 is disposed behind the lens. However, the infrared sensor 200 may also be located on the exterior of the illumination device, depending on design preference. According to a preferred embodiment, the remote control 204 is operable with the infrared sensor 200 to remotely operate the electronic control unit that directs power from the power source for illuminating the LED module 106.

According to an alternative embodiment, the LED module 106 emits a plurality of colors. According to this embodiment, the remote control 204 is operable with the infrared sensor 200 to change the color of the LED module 106. In a preferred embodiment, the remote control 204 determines the pattern of light emitted by the LED module 106. For example, for a white light, the remote control 204 can be pushed a first time. For a blue light, the remote control may be pushed a second time. For a red light, the remote control is pushed three times. For a green light, the remote control is pushed a fourth time. To turn the light off, the remote control is pushed a fifth time. However, one having ordinary skill in the art will recognize that there are numerous ways to change the colors and patterns of the LED module.

In the event that the remote control 204 is not available, the control unit may be controlled by the on/off button 122.

Optionally, the illumination device may also include a charge indicator light 202 which changes between a green and red color. When the power source is running low, the charge indicator light will become red. When the power level is sufficient, the charge indicator will remain green. Preferably, the charge indicator is a 0.200 RG LED which changes from red to green.

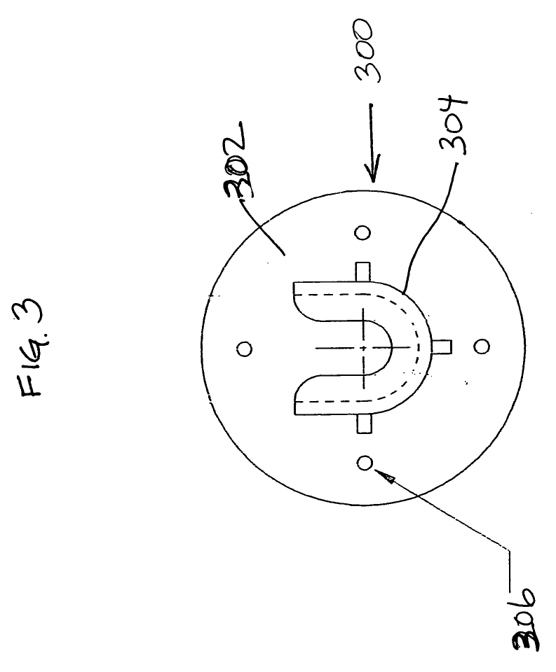

With reference to FIG. 3, the illumination device may be mounted to a surface via a mounting bracket 300. The mounting bracket 300 includes a plate 302 with a U-shaped bracket 304 mounted thereon. The plate 302 and U-shaped bracket 304 may be formed integrally, or formed separately and then mounted together permanently. Plate 302 allows for the mounting bracket 300 to be connected to a surface, such as a pool surface. Preferably, the mounting bracket 300 is attached to a surface via screws (not shown) which are mounted through a plurality of holes 306. Alternatively, the mounting bracket 300 may be affixed to a surface via a two-part epoxy. When mounting the illumination device to a wet surface, a two-part epoxy may be used that can be applied underwater. The mounting disk 126 comes in different sizes to compensate for varying diameters in pools.

With reference to FIGS. 1 and 3, the illumination device 100 is mounted onto the mounting bracket 300 by way of the mounting disk 126. In particular, the mounting disk 126 enters and is supported by the U-shaped bracket 304, such that the disk rests securely within the U-shaped bracket 304. In order to remove the illumination device 100 from the mounting bracket 300, the illumination device 100 and mounting disk 126 is simply moved upward out of the U-shaped bracket. The device can be mounted to the side of any surface using the mounting disk and mounting bracket and/or an underwater epoxy system. For example the illumination device may be mounted to the side of a swimming pool, on a boat or a dock. In addition, the illumination device may be mounted on trees or other surfaces for camping and backyard illumination including landscaping features.

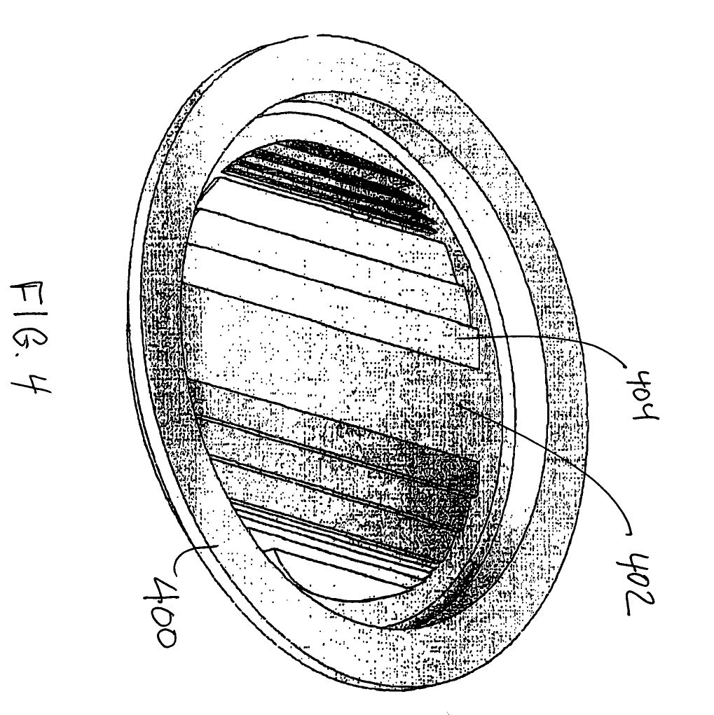

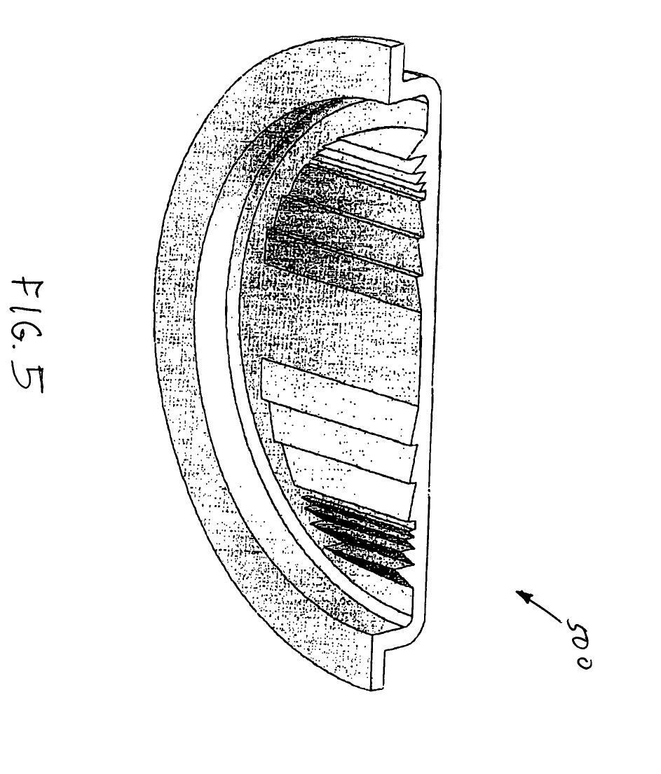

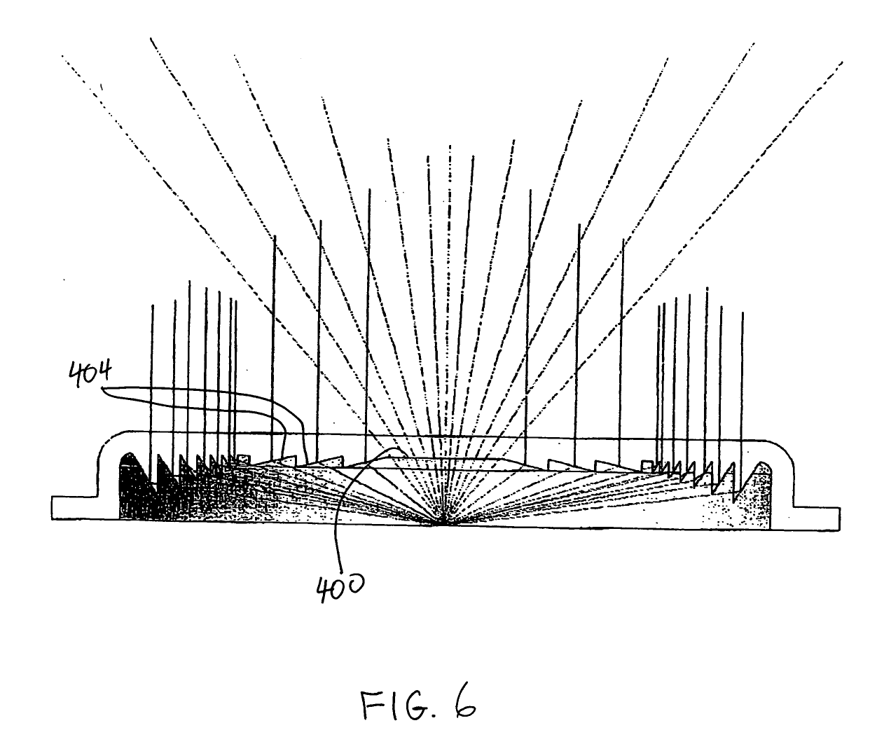

With reference to FIGS. 4-6, the preferred embodiment of the lens 400 includes a relatively planar front surface 402. Preferably, the center of the lens is relatively flat, to refract light at various angles, as shown in FIG. 6. However, the lens 400 includes a plurality of ridges 404, which are angled from the front surface 402. The ridges 404 are shaped so as to emit light at an angle perpendicular to the front surface of the lens 400, as shown in FIG. 6. FIG. 5 shows a perspective view of the lens 500 divided in half, showing the landscape of the ridges. The shape of the lens maximizes the light emitted to the pool by directing most of the light rays perpendicular from the front surface so that the light is directed sidewardly. In addition, the front surface or center of the lens remains so as to also emit light downwardly.

In one embodiment, the lens is designed to emit the light in downward horizontal directions, in order to keep as much light as possible in the pool.

The illumination device of the present invention also includes a restrictor chip or electronic driver that regulates the battery to give only the required amount of milliamps to operate the LED module efficiently. The electronic driver is mounted behind the LED module inside the electronics mount.

In another embodiment, the housing 102 may include slots 125 extending through the base. The slots 125 enable the housing to be fastened to a tree, pole, or other surface with a strap.

The present device is safe, using rechargeable batteries with no risk of fire or electrocution through external electrical currents. The illumination device of the present invention provides multiple uses for underwater illumination inexpensively. It also offers convenience with remote control access to operations.

The presently disclosed embodiments are considered in all respects to be illustrative and not restrictive. The scope is indicated by the appended claims, rather than the foregoing description, and all changes that come within the meaning and range of equivalence thereof are intended to be embraced.

1. An illumination device, comprising:
a housing;
a lens disposed at an end of the housing, the lens being in a watertight engagement with the housing;
at least one LED disposed in the housing, the at least one LED for transmitting light through the lens;
a power source;
an electronic control unit for directing power from the power source to the at least one LED; and
an infrared sensor operatively connected to the electronic control unit for remotely operating the electronic control unit.

2. The illumination device of claim 1, wherein the infrared sensor is disposed behind the lens.

3. The illumination device of claim 1, wherein at least one LED is operable to emit a plurality of colors.

4. The illumination device of claim 3, further comprising a remote control to operate the infrared sensor to change the color of the at least one LED bulb.

5. The illumination device of claim 1, further comprising a remote control to operate the infrared sensor to remotely operate the electronic control unit.

6. The illumination device of claim 1, further comprising:
an on/off button for activating and deactivating the power source.

7. The illumination device of claim 1, further comprising:
a charge indicator light which changes between green and red.

8. The illumination device of claim 1, wherein the lens is shaped to transmit light at an angle substantially perpendicular to a front surface of the lens.

9. The illumination device of claim 1, wherein the electronic control unit includes an electronic driver for regulating power from the power source to the at least one LED.

10. A mountable illumination device, comprising:
a housing;
a light source disposed at an end of the housing;
a backing plate disposed at an opposite end of the housing; and
a mounting disk attached to the backing plate, the mounting disk for removably mounting the illumination device to a mounting bracket on a surface.

11. The mountable illumination device of claim 10, wherein the mounting bracket is mountable to the surface by glue.

12. The mountable illumination device of claim 10, wherein the mounting bracket is secured to the surface via a plurality of screws.

13. The illumination device of claim 10, further comprising one or more slots extending through the housing to enable the device to be mounted by a strap.

14. An illumination device, comprising:
a housing;
a lens disposed at an end of the housing, the lens being in a watertight engagement with the housing;
at least one light source disposed in the housing, the at least one light source transmitting light through the lens, the lens being shaped so that light is transmitted at an angle substantially perpendicular to a front surface of the lens.

15. The illumination device of claim 14, wherein the lens includes a plurality of ridges distributed on the front surface of the lens, the ridges transmitting light at an angle substantially perpendicular to the front surface of the lens.

16. The illumination device of claim 14, further comprising one or more slots extending through the housing to enable the device to be mounted by a strap.
